(19) United States
(12) Patent Application Publication
(10) Pub. No.: US 2023/0094697 A1
(43) Pub. Date: Mar. 30, 2023

(54) Steering System with Protective Bellows and Puncture Resistant Covers

(71) Applicant: Robert Bosch GmbH, Stuttgart (DE)

(72) Inventor: Trevor Nill, Macomb, MI (US)

(21) Appl. No.: 17/943,908

(22) Filed: Sep. 13, 2022

Related U.S. Application Data
(60) Provisional application No. 63/250,406, filed on Sep. 30, 2021.

(51) Int. Cl. F16J 3/04; B62D 7/16

(52) U.S. Cl. CPC F16J 3/042; B62D 7/163

(57) ABSTRACT

One aspect of this disclosure is directed to a Steering system comprising a housing in inch a steering rack is movably arranged and extends out of the housing on at least one side of the housing with a steering rack end portion. The steering rack being connected to a tie rod with a ball joint. At least the sections of the steering rack extending outside of the housing and the ball joint are covered by at least a protective bellows defining a central axis and the bellows further comprising a first bellows end defining a first bellows opening around the central axis and a second bellows end defining a second bellows opening around the central axis. The bellows is arranged inside a puncture resistant cover. The cover comprises a first cover end defining a first cover opening around the central axis and a second cover end defining a second cover opening around the central axis. At least one of the cover ends comprises at least one loop at least partially extending around the least one cover end and in which loop a clamp to fasten the cover end is arranged. The first bellows end and the second bellows end are arranged between the first cover end and the second end. Another aspect of this disclosure is directed to a puncture resistant cover with an elongated tubular shape along a central axis. The cover comprises a first cover end defining a first cover opening around the central axis and a second cover end defining a second cover opening around the central axis. At least one of the cover ends comprises at least one loop at least partially extending around the least one cover end and in which loop a clamp to fasten the cover end is arranged.

### TECHNICAL FIELD

The present invention relates to vehicle steering system with protective bellows and puncture resistant covers.

### BACKGROUND

Automotive steering systems have steering racks that extend out of a housing and are connected to tie rods via ball joints. Protective bellows are used to cover and protect these connections. Particularly in harsher environments there is an increased risk of punctures by sticks or rocks that get thrown up. This may result in undesirable steering feel, degradation of steering function, and potentially blocking of steering motion if left unresolved for a long period of time. This may also allow water and contaminants to enter the steering system. Punctured bellows might require the steering system to eventually be replaced if not repaired in time.

### SUMMARY

One aspect of this disclosure is directed to a steering, system comprising a housing in which a steering rack is movably arranged and extends out of the housing on at least one side of the housing with a steering rack end portion, the steering rack being connected to a tie rod with a ball joint, wherein at least the sections of the steering rack extending outside of the housing and the ball joint are covered by at least a protective, bellows defining a central axis and the bellows further comprising a first bellows end defining a first bellows opening around the central axis and a second bellows end defining a second bellows opening around the central axis, the bellows being arranged inside a puncture resistant cover, the cover comprising a first cover end defining a first cover opening around the central axis and a second cover end defining a second cover opening around the central axis, wherein at least one of the cover ends comprises at least one loop at least partially extending around the least one cover end and in which loop a clamp to fasten the cover end is arranged. This allows to incorporate the clamps into the design of the cover which helps to prevent or reduce slipping of fabric of the cover from under the clamps. The cover has certain elastic properties allowing it to stretch slightly while fully extended. While being compressed the cover is allowed to bunch up. The cover will not necessarily be a sealing interface. This will still be handled by the bellows underneath the puncture resistant cover.

Another aspect of this disclosure is directed to a steering system comprising a housing in which a steering rack is movably arranged and extends out of the housing on at least one side of the housing with a steering rack end portion, the steering rack being connected to a tie rod with a ball joint, at least the sections of the steering rack extends outside of the housing and the ball joint are covered by at least a protective bellows defining a central axis and the bellows further comprising a first bellows end defining a first bellows opening around the central axis and a second bellows end defining a second bellows opening around the central axis, the bellows being arranged inside a puncture resistant cover, the cover comprising a first cover end defining a first cover opening around the central axis and a second cover end defining a second cover opening around the central axis, wherein, along the central axis, the first bellows end and the second bellows end are arranged between the first cover end and the second end.

Another aspect of this disclosure is directed to a puncture resistant cover with an elongated tubular shape along a central axis, the cover comprising a first cover end defining first cover opening around the central axis and a second cover end defining a second cover opening around the central axis, wherein at least one of the cover ends comprises at least one loop at least partially extending around the least one cover end and in which loop a clamp to fasten the cover end is arranged.

In some embodiments, the first cover end comprises a first loop in which a first clamp is arranged and the second cover end comprises a second loop in which a second clamp is arranged.

in some embodiments, the first bellows end is attached to the housing with a first bellows clamp, the second bellows end is attached to one of the tie rod and ball joint with a second bellows clamp, and the first cover end is attached to the housing with a first cover clamp and the second cover end is attached to one of the tie rod and ball joint with a second cover clamp.

In some embodiments, the first cover opening has a larger diameter than the second cover opening.

In some embodiments, in an unclamped state, the first cover opening has a larger diameter than the largest outer diameter of the bellows.

The above aspects of this disclosure and other aspects will be explained in greater detail below with reference to the attached drawings.

### BRIEF DESCRIPTION OF THE DRAWINGS

FIG. 1 depicts a partial longitudinal section of a steering system according to this disclosure.

FIG. 2 depicts an enlarged portion of FIG. 1.

FIG. 3 depicts a tubular cover of FIGS. 1 and 2.

FIG. 4 depicts a further puncture resistant cover.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed, are not to be interpreted as limiting, but as a representative basis for teaching one skilled in the art how to practice the disclosed concepts.

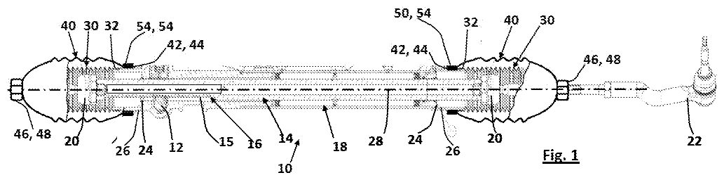

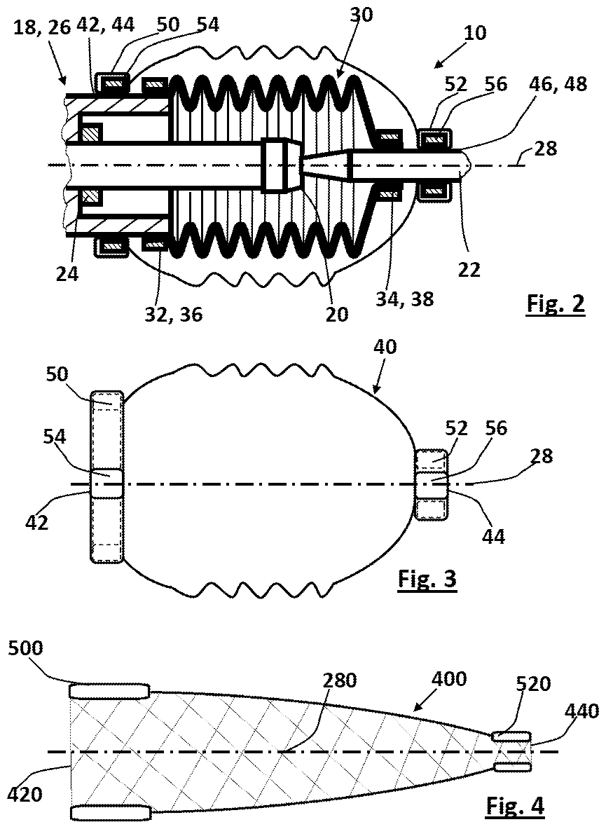

FIGS. 1 and 2 depict a steering system or steering rack assembly 10. The steering system may be a power steering system or a manual steering system. The steering rack assembly 10 includes a pinion 12 and a steering rack 14. The pinion 14 is in engagement with teeth 15 of a toothed member 16 of the steering rack 14. The steering rack 14 has the shape of a hollow tube. But solid steering racks or steering racks with different cross sections may be used as well. The steering rack 14 is mounted in a tubular housing 18. Ball joints 20 are attached on each axial end of the steering rack 14. Each ball joint 20 is connected to a tie rod 22 of which only one is shown. The steering rack 14 is supported by two bearings 24 that are located inside the housing 18. The housing 18 has end, sections 26 that extend beyond the beatings 24. The steering rack 14 is movably arranged and extends out of the housing 18 on both sides but should extend at least on one side of the housing 18. The steering rack 14 and housing 18 define a longitudinal or central axis 28 along which the steering rack 14 travels in operation. The tie rod 22 is shown in a straight line with the central axis 28. But, depending on the configuration or application, the tie rod 22 may be arranged at an angle to the central axis 28.

Sections of the steering rack 14 extending outside of the housing 18, the ball joints 20 and the part of the tie rods 22 adjacent to the ball joints 20 being covered by protective bellows. 30. The bellows 30 in automotive applications are also called gaiters or boots. Alternatively, if the ball joints 20 are sufficiently sealed, the bellows 30 may be attached to the ball joints 20 and not on the adjacent part of the tie rods 22. The bellows 30 cover therefore at least the steering rack 14 extending outside of the housing 18 and the ball joints 20 or in addition sections of the tie rods 22. The bellows 30 also define the central axis 28. It shall be noted that the central axis 28 may be angled at the ball joint 20 due to the suspension of a vehicle moving up and down and/or the wheels of a vehicle being turned. The bellows 30 further comprise a first bellows end 32 defining a first opening around the central axis 28 and a second bellows end 34 defining a second opening around the central axis 28. The first bellows ends 32 are connected to the outside of the end sections 26 of the housing 18 with a first bellows clamp 36. The second ends 34 are connected to the tie rods 22 with a second bellows clamp 38 (FIG. 2). The area of the bellows 30 adjacent to the second ends 34 are not shown as a longitudinal sectional view in. FIG. 1.

The bellows 30 are arranged inside a puncture resistant cover 40. The cover 40, Which could also be called a sock, may have an elongated tubular shape and comprises a first cover end 42 defining a first cover opening 44 around the central axis 28 and a second cover end 46 defining a second cover opening 48 around the central axis 28. The first bellows end 32 and the second bellows end 34 are arranged between the first cover end 42 and the second end 46 along the central axis 28. The first cover end 42/the first cover opening 44 has a larger diameter than the second cover end 46 the second cover opening 48. The first cover end 42 comprises a first cover loop 50.

The second cover end 46 comprises a second cover loop 52. In the depicted embodiment both cover ends 42, 46 comprise at least one loop 50, 52 at least partially extending around both cover ends 42, 46. But at least one cover end 42, 46 may have a loop 50, 52. A first cover clamp 54 to fasten or attach the first cover end 42 to the housing 18 is arranged in the first cover loop 50. A second cover clamp 56 to fasten or attach the second cover end 46 to the housing 18 is arranged in the second cover loop 52. The loops 50, 52 may extend around most of the circumference of the cover 40 and have a radial opening to insert the clamps 54, 56. There might also be a certain number of loops 50, 52 arranged around the circumference of the cover 40 that each extend over a few degrees. There may be four loops 50, 52 arranged every 90° along the circumference each extending over 20°. The loops 50, 52 may be part of the cover 40 material that are folded back and attached to the cover 40. The loops 50, 52 may glued to the cover 40. They could be made from the same material or another material then the cover 40.

In an unclamped state, the first cover opening 44 may have a larger diameter than the largest outer diameter of the bellows 30. This allows the cover 40 to be slipped over the installed bellows 30 and then be attached to the housing 18 and tie rod 20. In operation, when the steering rack 14 moves, the cover 40 may stretch slightly while fully extended. This may be due to certain elastic properties. While being compressed the cover 40 is allowed to bunch up. The cover 40 is not necessarily a sealing interface. This will still be handled by the bellows 30 underneath the puncture resistant cover 40. Puncture resistant may prevent punctures to occur or at least mitigate the impact of objects.

Aramid fibers, short for aromatic. polyamides, typically known under brand names such as Kevlar, Nomex and Twaron, but also other polyamides (PA), implemented as “fiber+matrix”, may be used as material for the puncture resistant cover 40. Organic and inorganic fiber textiles may also be suitable. Textile construction, as well as ultra-high molecular weight polyethylene fibers (PE-UHMW) and further fiber+matrix and yarn-based composite materials may be used, too. The puncture resistance cover 40 once slipped around the bellows 30 may disperse the pressure from sharp objects reducing damage and punctures on the bellows material. The sharp objects could be rocks, sticks, general road debris, and other objects that may otherwise be forced into the bellows 30. This is especially useful for off-road vehicles and vehicles in harsh environments where vehicle uptime and durability is a key attribute

FIG. 4 depicts an alternative puncture resistant cover 400. The cover 400 has an elongated tubular shape along a central axis 280, defining a frustoconical shape. The cover 400 comprises a first cover end 420 defining a first cover opening around a central axis 280 and a second cover end 460 defining a second cover opening around the central axis 280. At least one of the cover ends 420, 460 comprises at least one loop 500, 520 at least partially extending around the least one cover end 420, 460 and in which loop 420, 460 a clamp 54, 56 (from the previously described embodiment) to fasten the cover end 420, 460 is arranged.

While exemplary embodiments are described above, it is not intended that these embodiments describe all possible forms of the disclosed steeling rack and bellows. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. Steering system comprising a housing in which a steering rack is movably arranged and extends out of the housing on at least one side of the housing with a steering rack end portion, the steering rack being connected to a tie rod with a ball joint, wherein at least the sections of the steering rack extending outside of the housing and the ball joint are covered by at least a protective bellows defining a central axis and the bellows further comprising a first bellows end defining a first bellows opening around the central axis and a second bellows end defining a second bellows opening around the central axis, the bellows being arranged inside a puncture resistant cover, the cover comprising a first cover end defining a first cover opening around the central axis and a second cover end defining a second cover opening around the central axis, wherein at least one of the cover ends comprises at least one loop at least partially extending around the least one cover end and in which loop a clamp to fasten the cover end is arranged, wherein the first cover end comprises a first loop in which a first clamp is arranged and the second cover end comprises a second loop in which a second clamp is arranged.

2. Steering system according to claim 1, wherein, along the central axis, the first bellows end and the second bellows end are arranged between the first cover end and the second end.

3. Steering system according to claim 1, wherein the first bellows end is attached to the housing with a first bellows clamp, the second bellows end is attached to one of the tie rod and ball joint with a second bellows clamp, and wherein the first cover end is attached to the housing with a first cover clamp and the second cover end is attached to one of the tie rod and ball joint with a second cover clamp.

4. Steering system according to claim 1, wherein the first cover opening has a larger diameter than the second cover opening.

5. Steering system according to claim 1, wherein, in an unclamped state, the first cover end has a larger diameter than the largest outer diameter of the bellows.

6. Steering system according to claim 1, wherein the cover is tubular in shape.

7. Steering system comprising a housing in which a steering rack is movably arranged and extends out of the housing on at least one side of the housing with a steering rack end portion, the steering rack being connected to a tie rod with a ball joint, wherein at least the sections of the steering tack extending outside of the housing and the ball joint are covered by at least a protective bellows defining a central axis and the bellows further comprising a first bellows end defining a first bellows opening around the central axis and a second bellows end defining a second bellows opening around the central axis, the bellows being arranged inside a puncture resistant cover the cover comprising a first cover end defining a first cover opening around the central axis and a second cover end defining a second cover opening around the central axis, wherein, along the central axis, the first bellows end and the second bellows end are arranged between the first cover end and the second end.

8. Steering system according to claim 7, wherein the first bellows end is attached to the housing with a first bellows clamp, the second bellows end is attached to one of the tie rod and ball joint with a second bellows clamp, and wherein the first cover end is attached to the housing with a first cover clamp and the second cover end is attached to one of the tie rod and ball joint with a second cover clamp.

9. Steering system according to claim 7, wherein at least one of the cover ends comprises at least one loop at least partially extending around the least one cover end and in which loop a clamp to fasten the cover end is arranged.

10. Steering system according to claim 7, wherein the first cover end comprises a first loop in which a first clamp is arranged and the second cover end comprises a second loop in which a second clamp is arranged.

11. Steering system according to claim 7, wherein the first cover opening has a larger diameter than the second cover opening.

12. Steering system according to claim 7, wherein, in an unclamped state, the first cover opening has a larger diameter than the largest outer diameter of the bellows.

13. Steering system according to claim 7, Wherein the cover is tubular in shape.

14. A puncture resistant cover with an elongated tubular shape along a central axis, the cover comprising a first cover end defining a first cover opening around the central axis and a second cover end defining a second cover opening around the central axis, wherein at least one of the cover ends comprises at least one loop at least partially extending around the least one cover end and in which loop a clamp to fasten the cover end is arranged.

15. Puncture resistant cover according to claim 14, wherein the first cover end comprises a first loop in which a first clamp is arranged and the second cover end comprises a second loop in which a second clamp is arranged.

16. Puncture resistant cover according to claim 14, wherein the first cover opening has a larger diameter than the second cover opening.
